(19) United States
(12) Patent Application Publication
(10) Pub. No.: US 2013/0318451 A1
(43) Pub. Date: Nov. 28, 2013

(54) COMPUTING DEVICE AND METHOD FOR SHARING MOUSE OF COMPUTING DEVICE

(71) Applicants: LIU-WEI WU, Tu-Cheng (TW); JIUN-RU HOU, Tu-Cheng (TW); HSIN-CHANG LAI, Tu-Cheng (TW)

(72) Inventors: LIU-WEI WU, Tu-Cheng (TW); JIUN-RU HOU, Tu-Cheng (TW); HSIN-CHANG LAI, Tu-Cheng (TW)

(21) Appl. No.: 13/650,108

(22) Filed: Oct. 11, 2012

(30) Foreign Application Priority Data
May 23, 2012 (TW) 101118278

(51) Int. Cl. G06F 3/048

(52) U.S. Cl. 715/754

(57) ABSTRACT

In a method for sharing a mouse, the cursor of the mouse is concealed when the cursor of the mouse is moved to the left side of the user interface of the computing device. Control coordinates of the cursor of the mouse of the computing device are transmitted to a connected electronic device. The control coordinates of the cursor of the mouse are transformed into a functioning cursor display on a touch screen of the electronic device according to the display position.

### BACKGROUND

1. Technical Field

Embodiments of the present disclosure relate to hardware control systems and methods, and more particularly to a computing device, a storage medium, and a method for sharing a mouse of a computing device.

2. Description of Related Art

In some cases, for example, while playing online games or drafting, a mouse is needed. However, an electronic device, such as tablet, does not have an external mouse, which can be inconvenient.

### BRIEF DESCRIPTION OF THE DISPLAYINGS

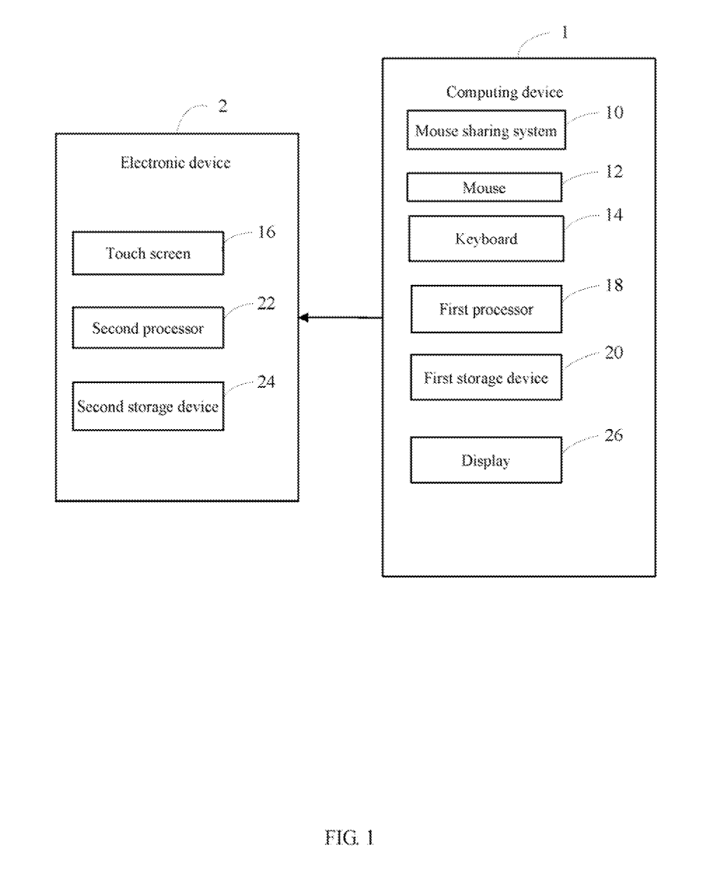

FIG. 1 is a block diagram of one embodiment of a computing device including a mouse sharing system.

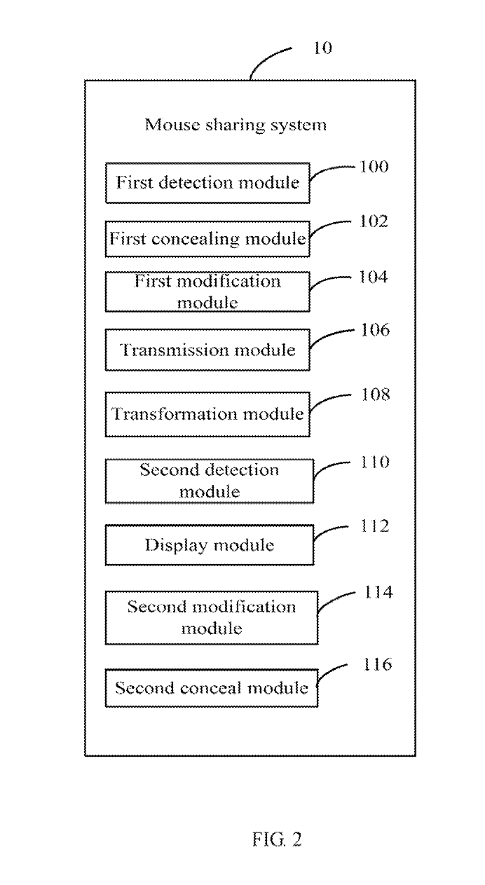

FIG. 2 is a block diagram of one embodiment of function modules of the mouse sharing system in FIG. 1.

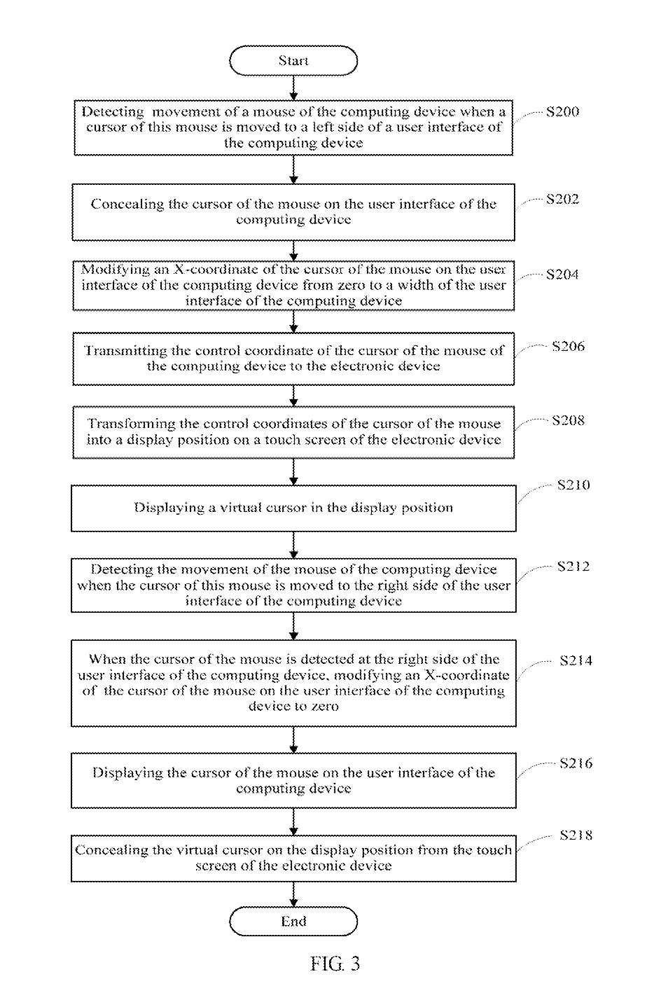

FIG. 3 illustrates a flowchart of one embodiment of a method for sharing mouse of the computing device 1 in FIG. 1.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

FIG. 1 is a block diagram of one embodiment of a computing device 1 including a mouse sharing system 10. In the embodiment, the computing device 1 is connected to an electronic device 2 through a USB cable, and the electronic device 2 may be located on the left side of the computing device 1, in one example. The computing device 1 includes a mouse 12, a keyboard 14, a first processor 18 and a first storage device 20. The electronic device 2 includes a touch screen 16, a second processor 22 and a second storage device 24. Each of the computing device 1 and the electronic device 2 is installed with the mouse sharing system 10 for sharing the mouse 12 of the computing device 1. The computing device 1 is installed with a first operating system, such as the WINDOWS operating system, the electronic device 2 is installed with a second operating system, such as the ANDROID operating system.

In one embodiment, the computing device 1 may be a computer, a notebook, a server or a workstation. The electronic device 2 may be a mobile device, such as a mobile phone, a personal digital assistant (PDA), or a tablet device.

The mouse 12 controls a user interface of the computing device 1. In one embodiment, the user interface may be generated by the first operating system of the computing device 1, and is displayed on a display 26 of the computing device 1. The keyboard 14 is an input device that is used to input data into the computing device 1. The touch screen 16 of the electronic device 2 is an electronic visual display that can detect the presence and location of a touch within the display area, and displays information of the electronic device 2.

In one embodiment, the mouse sharing system 10 includes a plurality of function modules (see FIG. 2 below), which include computerized code when executed by the first processor 18, to provide a method for sharing the mouse 12.

The first processor 18 and the second processor 22 may include a processor unit, a microprocessor, an application-specific integrated circuit (ASIC), and a field programmable gate array (FPGA), for example.

The first storage device 20 and the second storage 24 may include any type(s) of non-transitory computer-readable storage medium, such as a hard disk drive, a compact disc, a digital video disc, or a tape drive. The first storage device 20 stores the computerized code of the function modules of the mouse sharing system 10.

FIG. 2 is a block diagram of one embodiment of function modules of the mouse sharing system 10 of FIG. 1. In one embodiment, the mouse sharing system 10 may include a first detection module 100, a first concealing module 102, a first modification module 104, a transmission module 106, a transformation module 108, a second detection module 110, a display module 112, a second modification module 114 and a second concealing module 116. The functions of the function modules 100-116 are illustrated in FIG. 3 and described below.

FIG. 3 illustrates a flowchart of one embodiment of a method for sharing a mouse of the computing device 1. Depending on the embodiment, additional steps may be added, others removed, and the ordering of the steps may be changed.

In step S200, the first detection module 100 detects movement of the mouse 12 when a cursor of the mouse 12 is moved to a left side of the user interface of the computing device 1. In other embodiments, the first detection module 100 can detect movement of the mouse 12 when the cursor moves to other sides of the user interface such as the right side, top side, and bottom of the user interface.

In step S202, when the cursor of the mouse 12 is detected at the left side of the user interface, the first concealing module 102 conceals the cursor of the mouse 12 from view of the user interface on the display 26 For example, a coordinate system may be established in the user interface of the computing device 1. The coordinate system includes coordinates (x, y), where x refers to the distance along the horizontal axis and y refers to the distance along the vertical axis, and the lower-left corner vertex of the user interface of the computing device 1 is set as the origin (0,0). According to the coordinate system, the locations on the user interface of the computing device 1 are defined relative to the origin coordinate (0,0). When the cursor of the mouse 12 is at the left side of the user interface of the computing device 1, a control coordinate of the cursor of the mouse 12 may be defined as, for example, (Pw_x, Pw_y).

In step S204, the first modification module 104 modifies an X-coordinate of the control coordinates of the cursor of the mouse 12 from zero to a width of the user interface of the computing device 1 (the width of the user interface being denoted as “Width_win”). Therefore, for example, the control coordinates of the cursor of the mouse 12 may be modified as (Pw_x″, Pw_y″), wherein Pw_x″=Width_win, Pw_y″=Pw_y.

In step S206, the transmission module 106 transmits the control coordinates of the cursor of the mouse 12 to the electronic device 2 using a debug bridge (ADB) of the electronic device 2. In one embodiment, the ADB is a versatile command line tool that controls the computing device 1 to communicate with the electronic device 2 through the USB cable.

In step S208, the transformation module 108 transforms the control coordinates of the cursor of the mouse 12 into a display position (denoted as the display coordinates) on the touch screen 16 of the electronic device 2. For example, the width and height of the user interface of the computing device 1 may be defined as Width_win and Height_win, and the width and height of the user interface of the electronic device 2 may be defined as Width_droid, Height_droid, and the display coordinates from the computing device 1 to the electronic device 2 may be transformed from the control coordinate (Pw_x″, Pw_y″) of the cursor of the mouse 12 by a formula:

Pa_{—}x=(Pw_{—}x″×Width_droid)÷Width_win;

Pa_{—}y=(Pw_{—}y″×Height_droid)÷Height_win.

In step S210, the display module 112 displays a virtual cursor according to the display coordinates (Pa_x, Pa_y) using the ANDROID operating system of the electronic device 2, and displays the virtual cursor on the touch screen 16 of the electronic device 2.

In step S212, a second detection module 110 detects movement of the mouse 12 when the cursor of the mouse 12 is moved to the right side of the user interface of the computing device 1.

In step S214, when the cursor of the mouse 12 is detected at the right side of the user interface of the computing device 1, the second modification module 114 modifies the X-coordinate of the control coordinates of the cursor of the mouse 12 on the user interface of the computing device 1 to indicate zero.

In step S216, the display module 112 displays the cursor of the mouse 12 on the user interface of the computing device 1.

In step S218, the second concealing module 116 conceals the virtual cursor from the touch screen 16 of the electronic device 2.

Although certain embodiments have been specifically described, the present disclosure is not to be construed as being limited thereto. Various changes or modifications may be made to the embodiments without departing from the scope and spirit of the present disclosure.

What is claimed is:

1. A method of a computing device, the computing device electronically connected to an electronic device, the method comprising:
detecting movement of a mouse of the computing device when a cursor of the mouse is moved to a left side of a user interface of the computing device;
concealing the cursor of the mouse on the user interface of the computing device;
modifying an X-coordinate of the cursor of the mouse on the user interface of the computing device from zero to a width of the user interface of the computing device;
transmitting the control coordinate value of the cursor of the mouse to the electronic device; and
transforming the control coordinates of the cursor of the mouse into a display position on a touch screen of the electronic device;
displaying a virtual cursor of the mouse on the touch screen of the electronic device according to the display position.

2. The method according to claim 1, further comprising:
modifying a X-coordinate of the cursor of the mouse on the user interface of the computing device to zero when the cursor of the mouse is detected at the right side of the user interface of the computing device;
concealing the virtual cursor from the touch screen of the electronic device.

3. The method according to claim 1, further comprising:
displaying the cursor of the mouse on the user interface of the computing device.

4. A computing device connected to an electronic device, the computing device comprising:
a mouse;
a storage device;
at least one processer; and
one or more modules that are stored in the storage device and executed by the at least one processer, the one or more modules comprising instructions to:
detect a movement of a mouse of the computing device when a cursor of the mouse is moved to a left side of a user interface of the computing device;
conceal the cursor of the mouse on the user interface of the computing device;
modify an X-coordinate of the cursor of the mouse on the user interface of the computing device from zero to a width of the user interface of the computing device;
transmit the control coordinate value of the cursor of the mouse to the electronic device; and
transform the control coordinates of the cursor of the mouse into a display position on a touch screen of the electronic device;
display a virtual cursor of the mouse on the touch screen of the electronic device according to the display position;

5. The computing device according to claim 4, wherein the one or more modules further comprises instructions to:
detect movement of the mouse of the computing device when the cursor of this mouse is moved to the right side of the user interface of the computing device;
modify an X-coordinate of the control coordinates of the cursor of the mouse on the user interface of the computing device to zero;
conceals the virtual cursor from the touch screen of the electronic device.

6. The computing device according to claim 4, wherein the one or more modules further comprises instructions to:
display the cursor of the mouse on the user interface of the computing device.

7. A non-transitory computer-readable storage medium having stored thereon instructions capable of being executed by a processor of a computing device, the method comprising:
detecting movement of a mouse of the computing device when a cursor of the mouse is moved to a left side of a user interface of the computing device;
concealing the cursor of the mouse on the user interface of the computing device;
modifying an X-coordinate of control coordinates of the cursor of the mouse on the user interface of the computing device from zero to a width of the user interface of the computing device;
transmitting the control coordinate value of the cursor of the mouse to the electronic device; and
transforming the control coordinates of the cursor of the mouse into a display position on a touch screen of the electronic device;
displaying a virtual cursor of the mouse on the touch screen of the electronic device according to the display position;

8. The storage medium according to claim 7, wherein the method further comprises:
modifying a X-coordinate of the cursor of the mouse on the user interface of the computing device to zero when the cursor of the mouse is detected at the right side of the user interface of the computing device;
concealing the virtual cursor from the touch screen of the electronic device.

9. The method according to claim 7, wherein the method further comprising:
displaying the cursor of the mouse on the user interface of the computing device.
